(19) United States
(12) Patent Application Publication
(10) Pub. No.: US 2017/0334176 A1
(43) Pub. Date: Nov. 23, 2017

(54) FLOATING SHRINK LABELS

(71) Applicant: Dow Global Technologies LLC, Midland, MI (US)

(72) Inventors: Cody W. Lawrence, Pearland, TX (US); Brian W. Walther, Freeport, TX (US)

(21) Appl. No.: 15/521,926

(22) PCT Filed: Nov. 10, 2015
(86) PCT No.: PCT/US2015/059968

§ 371 Date: Apr. 26, 2017

Related U.S. Application Data
(60) Provisional application No. 62/097,858, filed on Dec. 30, 2014.

(51) Int. Cl. B32B 27/08; B32B 27/36; B32B 27/20; B32B 27/32

(52) U.S. Cl. CPC B32B 27/08; B32B 27/32; B32B 27/36; B32B 27/20; B32B 2307/72; B32B 2307/736; B32B 2519/00; B32B 2250/02

(57) ABSTRACT

A multi-layer shrink film comprising, consisting of, or consisting essentially of at least two layers, Layer A and Layer B, wherein Layer A is at least one skin layer comprising an amorphous glassy polymer material and Layer B is at least one core layer comprising i) 15-100 weight percent of a maleic anhydride-modified plastomer having a density in the range of 0.86-0.925 g/cm³; and ii) optionally a polyolefm which does not contain maleic anhydride having a density in the range of 0.86-0.925 g/cm³ and wherein the multi-level shrink film has an overall density of less than 1.0 g/cm³, is disclosed.

### REFERENCE TO RELATED APPLICATIONS

The present application claims the benefit of U.S. Provisional Application No. 62/097,858, filed Dec. 30, 2014, which is incorporated herein by reference in its entirety.

### BACKGROUND OF THE INVENTION

Plastic film recycling is typically a multi-step process with four key steps in the process.

1. Size reduction—Recycle film scrap must be converted from monolithic film of various lengths and widths to a more uniform particulate size or flake. This is accomplished most typically via a shearing process where the film is exposed to a shearing device which reduces the film into flakes. For multi-layer films these high shear forces may induce interlayer delamination. A variety of polymers and multi-layer films may be ground together.

2. Sorting—Since the initial size reduction step is random in nature, the resulting stream is sized so that oversized flakes are returned to the initial grinding step.

3. Separation and cleaning—The separation step is multi-faceted with a range of steps including metal separation, FTIR identification/separation step, and a density separation step where the flakes are charged to a high pH water bath that serves as a separation and washing step. Flakes with a composite density materials <0.95 g/cm3 will typically float to the surface within the time frame allowed for this step. Materials with densities >1.0 will sink in the wash and separation step and will be collected for further processing.

4. Drying and compaction—Both of the lower and higher density streams will be further washed to remove contamination and then dried prior to compaction into pellets via a melting and pelletization step.

To one skilled in the art, there are various approaches to achieve the results described in steps 1 to 4. It is critical to have nearly complete separation between the various polymer types. For example, nearly complete separation is needed between polyethylene terephthalate (PET) and glycol-modified polyethylene terephthalate (PETg). This is because PETg shrink labels have the same density as the bottles to which they are affixed, enabling labels to sink with the bottles. The ink that is on these shrink labels then contaminates the PET, dramatically reducing the clarity of the resulting unseparated composite sample. Therefore, PETg films with lower densities are desirable.

### SUMMARY OF THE INVENTION

A multi-layer shrink film comprising, consisting of, or consisting essentially of at least two layers, Layer A and Layer B, wherein Layer A is at least one skin layer comprising an amorphous glassy polymer material and Layer B is at least one core layer comprising i) 15-100 weight percent of a maleic anhydride-modified plastomer having a density in the range of 0.86-0.925 g/cm³; and ii) optionally a polyolefin which does not contain maleic anhydride having a density in the range of 0.86-0.925 g/cm³ and wherein the multi-level shrink film has an overall density of less than 1.0 g/cm³, is disclosed.

### DETAILED DESCRIPTION OF THE INVENTION

In a broad embodiment of the present invention, there is provided a multi-layer shrink film comprising, consisting of, or consisting essentially of at least two layers, Layer A and Layer B;

Layer A is at least one skin layer comprising an amorphous glassy polymer material

and Layer B is at least one core layer comprising i) 15-100 weight percent of a maleic anhydride-modified plastomer having a density in the range of 0.86-0.925 g/cm³; and ii) optionally a polyolefin which does not contain maleic anhydride having a density in the range of 0.86-0.925 g/cm³ wherein the multi-level shrink film has an overall density of less than 1.0 g/cm³.

A shrink film is any film where the application of heat will induce a reduction in dimension. The current invention anticipates that the dimensional reduction can be in one direction (unidirectional) or in both directions (bidirectional). To one skilled in the art there are multiple methods to induce the retraction in dimensional shape but most typically this is accomplished by exposing the film to a heat source. Optimally, the force to shrink the film will be uniform. Achieving a uniform retraction force is uniquely challenging in a multilayer structure where the various layers may shrink at different temperatures or rates which may introduce a non-uniform film thickness. While not being limited to the present example, an optimal multi-layer shrink film would be one where one layer would provide the shrink force and the other layer would have minimal resistance to these retractive forces. While not being bound to the theory, a high level of crystallinity in a layer of a multi-layer structure could introduce a non-uniform shrink rate to a multi-layer structure.

Layer A. Skin Layer

The skin layer comprises an amorphous glassy polymer material and is on the outside of the film. Amorphous glassy polymers are those which have a glass transition temperature (as determined from the appropriate peak in tan(delta) curve measured using dynamic mechanical thermal analysis) above room temperature and are substantially amorphous (that is a crystallinity less than about 10 weight percent, as determined by, for example, wide angle x-ray diffraction). Amorphous glassy polymers include polystyrene materials (for example GPPS, HIPS, K RESIN, SIS, SBS, SEBS) as well as PETg, amorphous PET, amorphous PLA or PVC. In an embodiment, Layer A is PETg.

The skin layers comprise from 1 percent by weight to 40 percent. Any and all ranges between 1 and 40 percent are included herein and disclosed herein, for example, the skin layers can comprise from 2 to 33 weight percent, 5 to 25 weight percent, or 10 to 20 weight percent, based on the total weight of the shrink film.

Layer B. Core Layer

The core layer is adjacent to the skin layer. The core layer comprises a polymer with a maleic anhydride (MAH)-modified plastomer. In an embodiment, the MAH is grafted to the plastomer. In a further embodiment, the MAH-graft level is from 0.01 to 2 weight percent, based on the weight of the MAH-grafted plastomer, thereby providing a core layer with MAH content in the range of from 0.01 to 2 weight percent. In a further embodiment, the MAH-graft level is from 0.1 to 1.5 weight percent, based on the weight of the MAH-grafted polymer. In a further embodiment, the MAH-graft level is from 0.5 to 1.3 weight percent, based on the weight of the MAH-grafted polymer.

In one embodiment, the core layer comprises a MAH-grafted ethylene-based polymer. In a further embodiment, the MAH-grafted ethylene-based polymer has a melt index (I2) from 0.5 to 15 g/10 min, or from 1 to 10 g/10 min.

In one embodiment, the functionalized MAH-grafted ethylene-based polymer comprises at least one functional group selected from the following:

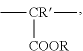

anhydride, and combinations thereof; and wherein R is hydrogen or alkyl, R′ is hydrogen or alkyl. In a further embodiment, each alkyl group is, independently, methyl, ethyl, propyl or butyl. In one embodiment, the functionalized ethylene-based polymer is selected from a functionalized ethylene homopolymer or a functionalized ethylene/alpha-olefin interpolymer. In a further embodiment, the functionalized ethylene-based polymer is a functionalized ethylene homopolymer. In another embodiment, the functionalized ethylene-based polymer is a functionalized ethylene/alpha-olefin interpolymer, and further a functionalized ethylene/alpha-olefin copolymer. Preferred alpha-olefins include C3-C8 alpha-olefins, and further propylene, 1-butene, 1-hexene and 1-octene.

In an embodiment, Layer B can have a maleic anhydride content in the range of from 0.01-2.0 weight percent. Any and all ranges between 0.01 and 2.0 weight percent are included herein and disclosed herein, for example, Layer B can have a maleic anhydride content in the range of from 0.1-1.5 weight percent, 0.2 to 1.3 weight percent, or 0.25-1.1 weight percent.

The maleic anhydride-modified plastomer has a density in the range of 0.860-0.925 g/cm³. Any and all ranges between 0.860 and 0.925 g/cm³ are included herein and disclosed herein, for example, the maleic anhydride-modified plastomer can have a density in the range of 0.863-0.920 g/cm³ or 0.870-0.910 g/cm³.

In various embodiments, the maleic anhydride (MAH)-modified plastomer is present in an amount in the range of from 15-100 weight percent, based on the total weight of the core layer. Any and all ranges between 15 and 100 weight percent are included herein and disclosed herein, for example, the MMI-modified plastomer is present in the core layer in an amount in the range of from 22-90 weight percent, from 35 to 82 weight percent, and 45 to 70 weight percent.

Layer B can optionally contain a polyolefin which does not contain maleic anhydride having a density in the range of 0.860-0.925 g/cm³. Examples of polyolefms include, but are not limited to ethylene/alpha-olefin copolymers such as ENGAGE™ EG 8100 (sold by the Dow Chemical Company), AFFINITY™ 8200G (sold by the Dow Chemical Company), or low density polyethylene (LDPE) such as LDPE 722 (sold by the Dow Chemical Company).

The optional polyolefin has a density in the range of 0.860-0.925 g/cm³. Any and all ranges between 0.860 and 0.925 g/cm³ are included herein and disclosed herein, for example, the optional polyolefin can have a density in the range of 0.875-0.920 g/cm³ or 0.88-0.920 g/cm³.

Layer A has a thickness percent of 1 to 99%. Any and all values between 1 and 99% are included herein and disclosed herein, for example, Layer A can have a thickness percent of from 2-89%, 10-80%, or 40-50%.

Layer B has a thickness percent in the range of 1 to 99%, based on the total thickness of the multi-layer shrink film. Any and all values between 1 and 99% are included herein and disclosed herein, for example, Layer B can have a thickness percent of from 2-89%, 10-80%, or 30-60%.

The multi-layer shrink film has an overall density of less than 1.0 g/cm³. Any and all densities less than 1.0 g/cm3 are included herein and disclosed herein, for example the multi-layer shrink film can have an overall density of less than 0.95 g/cm³. By having a density of less than 0.95 g/cm3, a label prepared from this multi-layer shrink film can float during the recycling process, enabling it to be separated from its bottle.

At the time of co-extrusion, the viscosity ratio of Layer A to Layer B is from 0.5:1 to 1.5:1. Any and all ranges between 0.5:1 and 1.5:1 are included herein and disclosed herein, for example, the viscosity ratio of Layer A to Layer B can be from 0.8:1 to 1.2:1 or 1:1 to 1.1:1.

The multi-layer shrink film may contain other additives such as mineral oil or other plasticizers, as well as other additives as is generally known in the art. This includes materials such as inorganic fillers, hollow glass beads, conductive fillers, pigments, antioxidants, acid scavengers, flame retardants, ultraviolet absorbers, processing aids such as zinc stearate, extrusion aids, slip additives, permeability modifiers, anti-static agents, antiblock additives and other thermoplastic polymers.

The multi-layer shrink film has a total haze value in the range of less than 10%. Any and all values less than 10% are included herein and disclosed herein, for example, the multi-layer shrink film has a total haze of less than 7%, 5%, 2%, or 1%.

The multi-layer shrink film has a 45 degree gloss of greater than 80%. Any and all values greater than 80% are included herein and disclosed herein, for example, the multi-layer shrink film can have a 45 degree gloss of 85%, 87%, 91%, or 95%.

The multi-layer shrink film also has sufficient adhesion to prevent interlayer delamination in either a grinding process or a liquid bath having a pH of greater than 6. Interlayer delamination is minimized when the adhesive bond between the Layer A and Layer B has a peel strength of greater than 150 N/m as measured using a peel adhesion test such as Peel Resistance of Adhesive (T-Peel Test) ASTM D1876. Some adhesives when exposed to moisture will significantly decrease their interlayer adhesion force. During the separation step of the recycle process the multilayer films are immersed in a high pH water solution with a pH greater than 6. The pH of the water separation stage may have its pH adjusted using any number of conventional additives such as sodium hydroxide, potassium hydroxide, calcium hydroxide, ammonia, or combinations thereof.

In an embodiment, the multi-layer shrink film is a 3 layer structure comprising Layer A/Layer B/Layer A with a thickness distribution of 10/80/10. For example, one can use Eastman EMBRACE™ LV copolyester as the two Layers A and, as Layer B, 50% AFFINITY™ PL 1850 from the Dow Chemical Company and 50% XUS 69106.01, also from The Dow Chemical Company. XUS 69106.01 is a maleic anhydride grafted polymer (density of 0.870 g/ccm, melt index (I2) of 4.5 g/10 (2.16 kg, 190° C.), and MAH level of greater than 0.25 wt %) prepared by reactive extrusion.

1. A multi-layer shrink film comprising a three layer structure arranged as Layer A/Layer B/Layer A with:
Layer A comprising skin layers comprising an amorphous glassy polymer material; and
Layer B at least one core layer comprising
i) 15-100 weight percent of a maleic anhydride-modified plastomer having a density in the range of 0.86-0.925 g/cm³; and
ii) optionally a polyolefin which does not contain maleic anhydride having a density in the range of 0.86-0.925 g/cm³
wherein the multi-layer shrink film has an overall density of less than 1.0 g/cm³.

2. The multi-layer shrink film of claim 1, wherein the peel strength between Layer A and Layer B is greater than 150 N/m.

3. The multi-layer shrink film of claim 1, wherein the peel strength between Layer A and Layer B is greater than 150 N/m after exposure to an aqueous bath having a pH of greater than 6.

4. The multi-layer shrink film of claim 1 wherein the multi-layer shrink film has an overall density of less than 0.95 g/cm³.

5. The multi-layer shrink film of claim 1 wherein the amorphous glassy polymer material comprises glycol-modified polyethylene terephthalate (PETg).

6. The multi-layer shrink film of claim 1 further comprising fillers.

7. The multi-layer shrink film of claim 1 wherein each Layer A has a thickness percent of 1 to 99% and Layer B has a thickness percent in the range of 1 to 99%, based on the total thickness of the multi-layer shrink film.

8. The multi-layer shrink film of claim 1 wherein the maleic anhydride-modified plastomer has a density of from 0.860 to 0.890 g/cm³.

9. The multi-layer shrink film of claim 1 wherein maleic anhydride is present in the core layer in the range of from 0.01 to 2.0 weight percent.

10. The multi-layer shrink film of claim 1 wherein the polyolefin which does not contain maleic anhydride has a density in the range of 0.860 to 0.890 g/cm³.

11. The multi-layer shrink film of claim 1 wherein, at the time of co-extrusion, the viscosity ratio of skin layer to core layer is from 0.5:1 to 1.5:1.

12. The multi-layer shrink film of claim 1 having a total haze of less than 10%.

13. The multi-layer shrink film of claim 1 having a 45 degree gloss of greater than 80%.
